(19) United States
(12) Patent Application Publication
(10) Pub. No.: US 2016/0169361 A1
(43) Pub. Date: Jun. 16, 2016

(54) Cold Planer Implement Drive Train Protection System

(71) Applicant: Caterpillar Paving Products Inc., Brooklyn Park, MN (US)

(72) Inventors: Benjamin T. Schafer, Elk River, MN (US); Daniel H. Killion, Blaine, MN (US)

(73) Assignee: Caterpillar Paving Products Inc., Brooklyn Park, MN (US)

(21) Appl. No.: 14/572,143

(22) Filed: Dec. 16, 2014

(51) Int. Cl. F16H 55/36; E01C 23/088; B60W 40/10; E01C 23/12; F16H 7/02; F16H 1/28

(52) U.S. Cl. CPC F16H 55/36; F16H 7/02; F16H 1/28; B60W 40/10; E01C 23/12; E01C 23/088; B60W 2300/17; B60W 2420/50; B60W 2510/0283; B60W 2520/04

(57) ABSTRACT

A drive train protection system includes an input pulley providing rotary movement to an implement drive gearbox, at least one sensor, and at least one clutch selectively engagable to provide rotary movement to the input pulley from the driver. The sensor is disposed to sense the rotation of an annular toothed surface of the input pulley to monitor input pulley speed and provide a signal indicative of the speed. The clutch is disengagable to disengage the input pulley from the driver in response to the signal indicative of the speed of the input pulley.

### TECHNICAL FIELD

This patent disclosure relates generally to road milling machines and, more particularly to a drive train protection system for a road milling machine.

### BACKGROUND

One type of road construction vehicle, commonly referred to as a road milling or cold planer machine, generally includes a machine frame and a rotor or milling head rotatably mounted on the machine frame. The milling head facilitates removing asphalt from a roadbed, which typically is transported to a discharge location such as a truck bed of a dump truck for disposal. Many road-milling applications include a risk of striking a buried or exposed object with the milling head. Obstacle strikes may cause severe damage to the milling head. Occasionally, such obstacle strikes cause damage to the drive train as well, which can include, for example, the rotor drive, gearbox, rotor support bearings, drive belts, clutch, machine frame, etc.

Various arrangements have been proposed to minimize such damage associated with obstacle strikes. For example, it is known to provide a sensor disposed to monitor the rotation of the rotor, or a gear within a rotor drive gearbox.

### SUMMARY

The disclosure describes, in one aspect, a drive train protection system for a machine having a rotatably-mounted implement and a drive train coupled to a driver and the implement. The drive train includes an implement drive gearbox selectively couplable to the implement to provide rotary movement. The driver is couplable to the implement drive gearbox by at least one input belt. The drive train protection system includes an input pulley coupled to the implement drive gearbox, the input belt being disposed to provide rotary movement to the input pulley, at least one sensor, and at least one clutch selectively engagable to provide rotary movement to the input pulley from the driver. The input pulley includes an annular toothed surface. The sensor is disposed to sense the rotation of the annular toothed surface to monitor a speed of the input pulley and provide a signal indicative of a speed of the input pulley. The clutch is disengagable to disengage the input pulley from the driver in response to the signal indicative of the speed of the input pulley.

The disclosure describes in another aspect, a cold planer having a frame supported on a plurality of ground engaging devices, a driver supported on the frame, a rotor, and a drive train coupled to the driver and the rotor. The drive train includes an implement drive gearbox coupled to the rotor to provide rotary movement, an input pulley, at least one input belt disposed to provide rotary movement to the input pulley, a power drive selectively couplable to provide rotary movement to the input belt. The input pulley is coupled to the implement drive gearbox, and includes an annular toothed surface. The cold planer further includes at least one sensor disposed to sense the rotation of the annular toothed surface to monitor a speed of the input pulley.

In yet another aspect, the disclosure describes a drive train for operation with an engine. The drive train includes a power drive coupled for selective operation with the engine, an implement drive gearbox, a rotatably-mounted implement disposed for operation with the implement drive gearbox, an input pulley disposed to transmit rotary movement to the implement drive gearbox, the input pulley including an annular toothed surface, an input belt disposed about the input pulley, and a selectively engagable clutch disposed to selectively engage the power drive with the input belt. At least one sensor is disposed to sense rotation of the annular toothed surface to monitor a speed of the input pulley and a provide a signal indicative of a speed of the input pulley. A machine controller is adapted to receive the signal and to provide a signal to disengage the clutch to disengage the power drive from the input belt when the implement encounters an obstacle.

### BRIEF DESCRIPTION OF THE DRAWING(S)

FIG. 1 illustrates a side isometric view of an exemplary machine having an implement drive train protection system, according to one embodiment of the present disclosure;

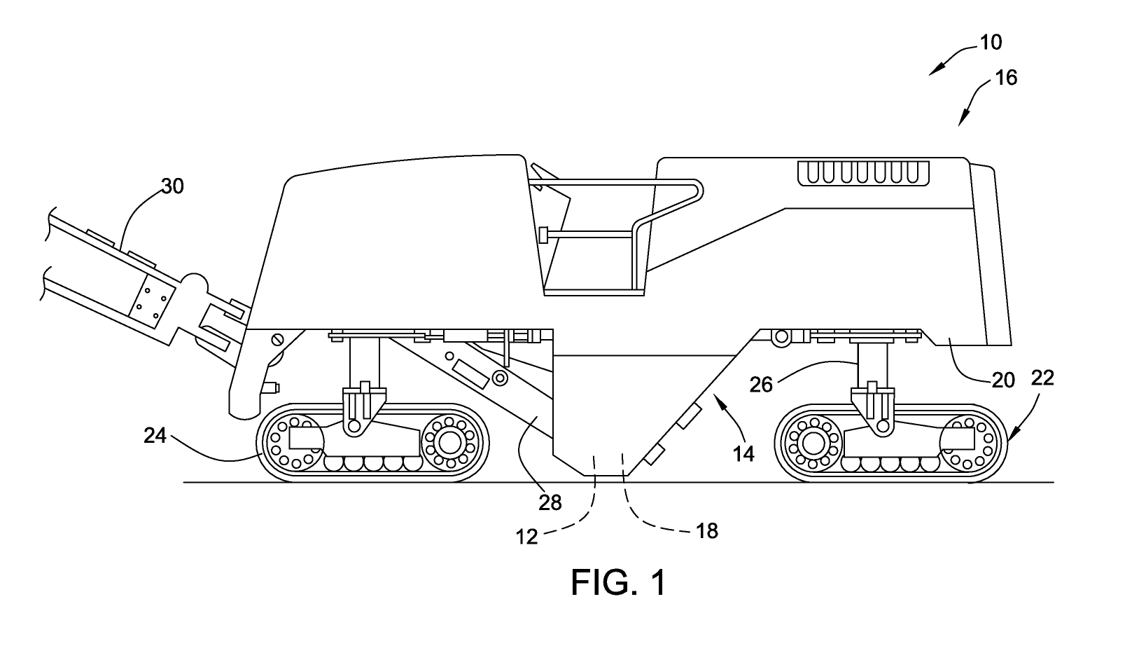

FIG. 2 is a schematic of a drive train and drive train protection system in accordance with aspects of this disclosure;

FIG. 3 illustrates an enlarged fragmentary isometric view of a portion of the drive train protection system of FIG. 1 with a cover removed;

FIG. 4 illustrates an enlarged fragmentary isometric view of the portion of the drive train shown in FIG. 3 from the bottom;

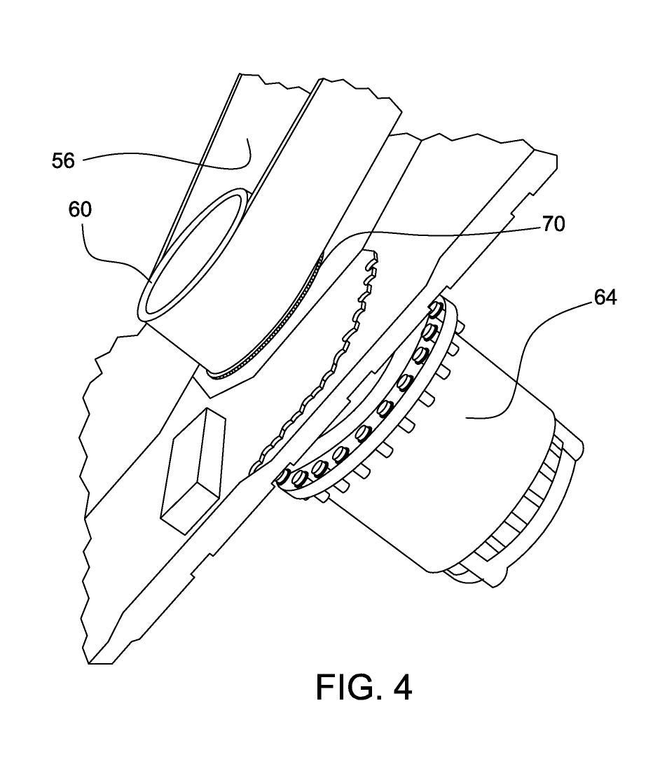

FIG. 5 illustrates a front elevational view of an input pulley and toothed ring of the drive train protection system of FIGS. 1-4;

FIG. 6 illustrates a side elevational view of the input pulley and toothed ring FIG. 1-5;

FIG. 7 illustrates an enlarged exploded view of a pickup sensor of the implement drive train protection system shown in FIGS. 1-4;

FIG. 8 illustrates logic for an exemplary method according to aspects of this disclosure; and

FIG. 9 illustrates logic for an exemplary method according to aspects of this disclosure.

### DETAILED DESCRIPTION

This disclosure relates to machine 10 having an implement 12 operated by a drive train 14 wherein the implement 12 may encounter obstacles that may cause sudden shocks resulting in severe damage to the drive train 14. While the arrangement is illustrated in connection with a cold planer 16 having a milling head or rotor 18, the arrangement disclosed herein has universal applicability in various other types of machines as well. The term “machine” may refer to any machine that performs some type of operation associated with an industry such as mining, construction, farming, transportation, or any other industry known in the art, wherein the machine 10 includes an implement operated by a drive train 14 wherein the implement 12 may encounter obstacles that may cause sudden shocks resulting in damage to the drive train 14. For example, the machine may be an earth-moving machine, or the like. Moreover, one or more implements may be connected to the machine. Such implements may be utilized for a variety of tasks and include, for example, milling heads, rotors, and others.

The machine 10 includes a frame 20 supported on a plurality of ground engaging devices 22. In the illustrated embodiment, the ground engaging devices 22 include drive tracks 24 configured for propelling the machine 10 along a road surface. The ground engaging devices 22 may include alternate or additional devices. The implement 12, such as a milling head or rotor 18, is also supported on the frame 20. The implement 12 may be utilized in milling the road surface. A cutting plane of the machine 10 is tangent to the bottom of the implement 12 and parallel to the direction of travel of the machine 10. The drive tracks 24 of the machine 10 are connected to the frame 20 of the machine 10 by hydraulic legs 26. The hydraulic legs 26 are configured to raise and lower the implement 12 relative to the drive tracks 24 so as to control a depth of cut for the implement 12. The machine 10 may be further equipped with one or more conveyors 28, 30 configured to transport excavated material from the implement 12 to a discharge location, such as the bed of a dump truck (not illustrated).

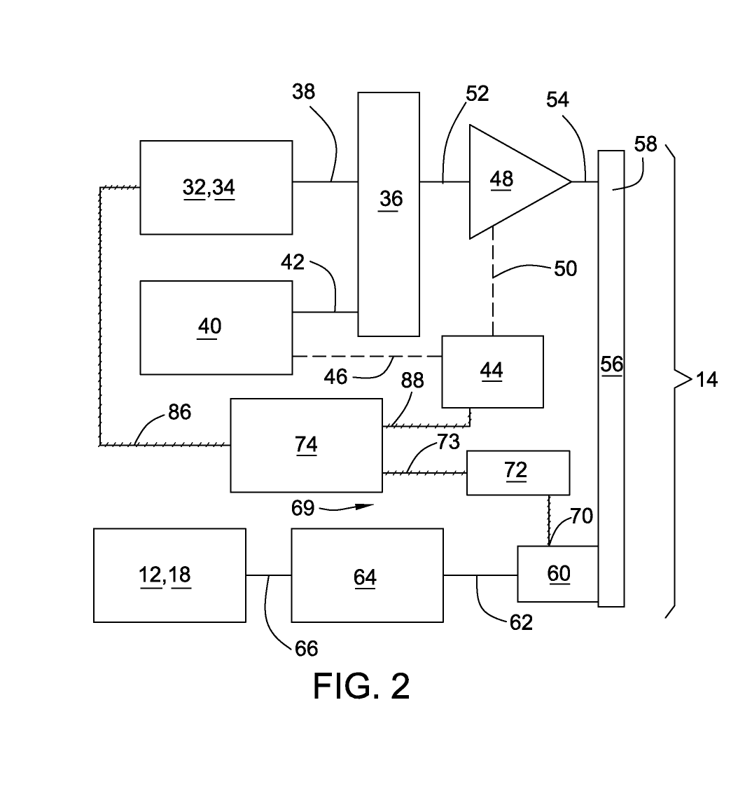

The machine 10 may further include a driver 32, such as an engine 34. The implement 12 is coupled to the driver 32 by way of the drive train 14, as schematically illustrated, for example, in FIG. 2. As illustrated, the solid connection lines indicate mechanical connections, the broken lines indicate hydraulic connections, and the hatched lines indicate electrical connections.

While the arrangement may be other than as illustrated in FIG. 2, in this embodiment, the engine 34 is mechanically coupled to a power drive arrangement 36. The mechanical connection may be by way of an output shaft 38 or the like (such as illustrated), or a take-off from the output shaft 38. The power drive arrangement 36 may include, for example, a transmission including a plurality of gears, clutches, and brakes (not separately illustrated). In some embodiments, the power drive arrangement 36 may include, for example, a planetary gearing system (not illustrated). It will be appreciated by those of skill that the power drive arrangement 36 may include a plurality of arrangements and systems driven by power from the engine 34.

Further, power from the power drive arrangement 36 may be output to one or more systems. For example, power from the power drive arrangement 36 may be utilized to drive one or more hydraulic pumps (not separately illustrated) as part of a hydraulic power system 40, as indicated by reference number 42. The flow of hydraulic fluid from hydraulic power system 40 may be coupled to drive other systems and components of the machine 10, such as clutch valve 44 (see hydraulic coupling 46) selectively operable to control clutch 48 (see hydraulic coupling 50). Those of skill will appreciate that the clutch 48 may be controlled by an alternate mechanism, such as electronically.

The power drive arrangement 36 may be further coupled to drive the implement 12, here, the rotor 18. In the illustrated embodiment, clutch 48 is selectively engagable with the power drive arrangement 36 by way of mechanical connections 52, 54 to transmit power from the driver 32 or engine 34, providing rotary power to an input belt 56. It will be appreciated that mechanical connection 54 may include, for example, a pulley 58, such that rotary power from the power drive arrangement 36 is transmitted by way of mechanical connections 52, 54 to the pulley 58 and input belt 56 when the clutch 48 is engaged.

Power is further transmitted by the input belt 56 through the drive train 14 to drive the implement 12, here, rotor 18. More specifically, the input belt 56 transmits mechanical rotation to a drive input pulley 60. The input pulley 60 further transmits rotary power by way of shaft 62 to an implement drive gearbox 64. The implement drive gearbox 64 may include a plurality of gears, clutches, and brakes (not separately illustrated). In some embodiments, the implement drive gearbox 64 may include, for example, a planetary gearing system (not illustrated). The implement drive gearbox 64 may, for example, reduce the rotational speed from the shaft 62 to an output 66 to the implement 12, i.e., the rotor 18 as illustrated.

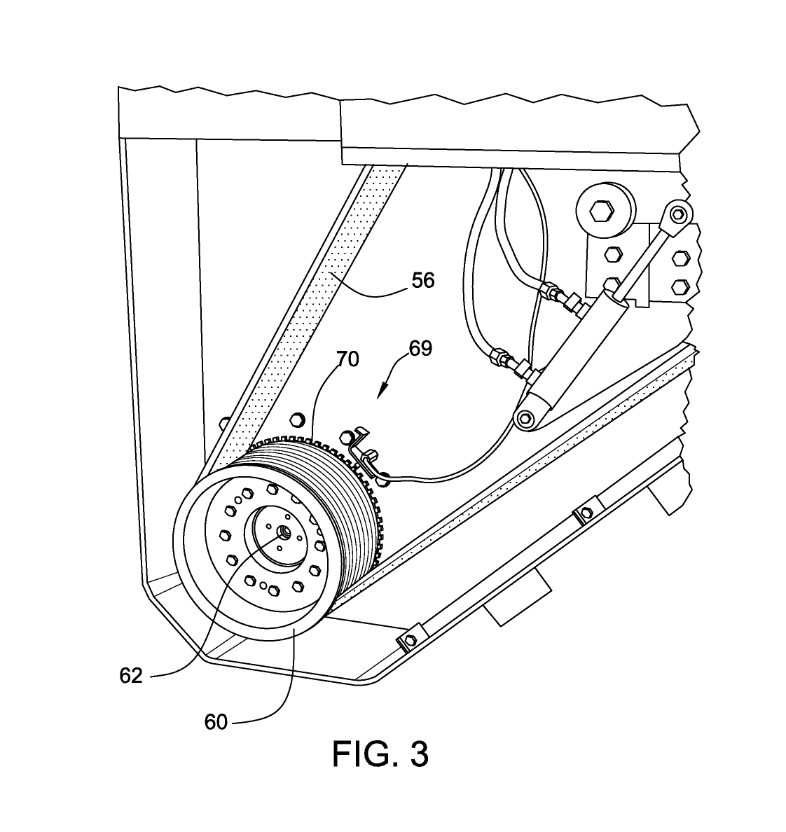

Turning to FIG. 3, according to an aspect of the disclosure, the machine 10 is provided with a drive train protection system 69. The drive train protection system 69 includes an annular toothed surface 70 disposed to rotate with the input pulley 60, and at least one sensor 72 disposed to sense the rotation of the annular toothed surface 70 to monitor a speed of the input pulley 60. In this way, the sensor 72 may provide a signal 73 indicative of the speed of the input pulley 60 to a machine controller 74 (see FIG. 2).

The annular toothed surface 70 may be of any appropriate design, so long as the sensor 72 may sense the rotational speed of the input pulley 60 based upon the passage of the teeth and valley past the sensor 72. The teeth and valleys are preferably uniformly spaced about the annular surface. In the particular embodiment illustrated, the teeth and valleys are of equal length, although they may differ from one another so long as the configuration is uniform about the annular surface.

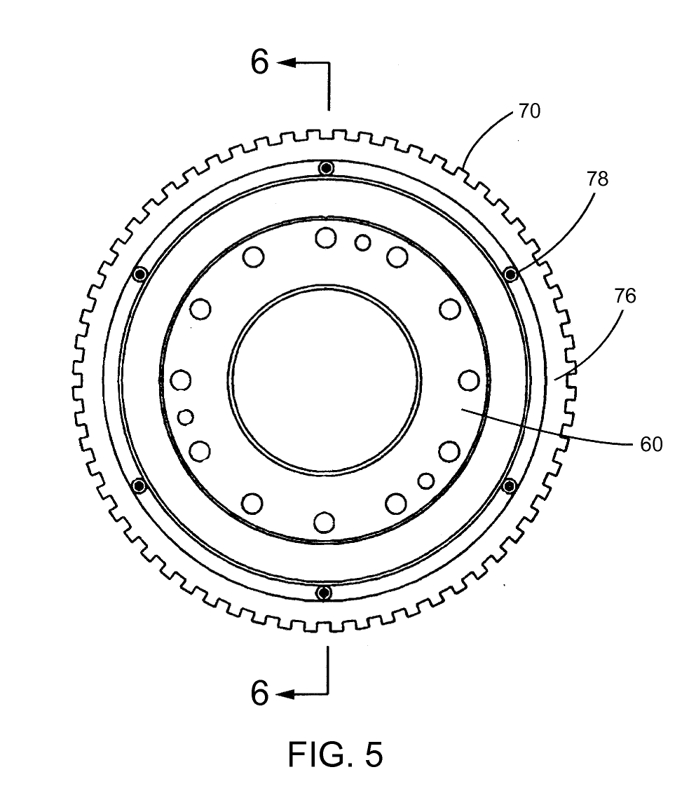

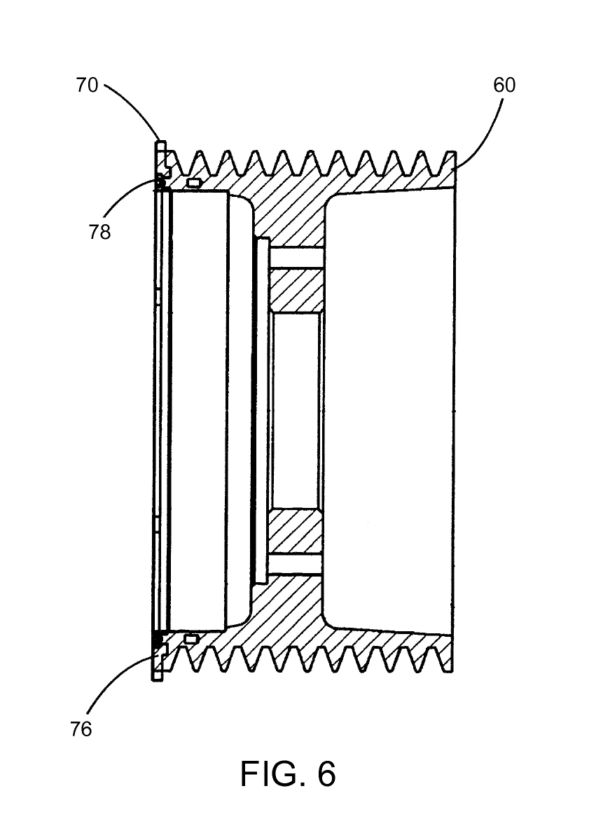

The annular toothed surface 70 may be integrally formed with the input pulley 60, or may be secured to the input pulley 60 for rotation with the input pulley 60. For example, the annular toothed surface 70 could be cast with the input pulley 60 if cast out of steel. By way of further example, the input pulley 60 and annular toothed surface 70 illustrated in FIGS. 5 and 6 can be separate components. The input pulley 60 may include a wheel structure having first and second sides bridged by an annular surface. The annular toothed surface 70 illustrated is in the form of a disk 76, which may then be secured to a wheel by any appropriate fastener, such as, for example, the illustrated plurality of bolts 78 to form the input pulley 60. Thus, it will be appreciated that such a disk 76 including the annular toothed surface 70 may be incorporated into existing machines as part of a retrofit drive train protection system.

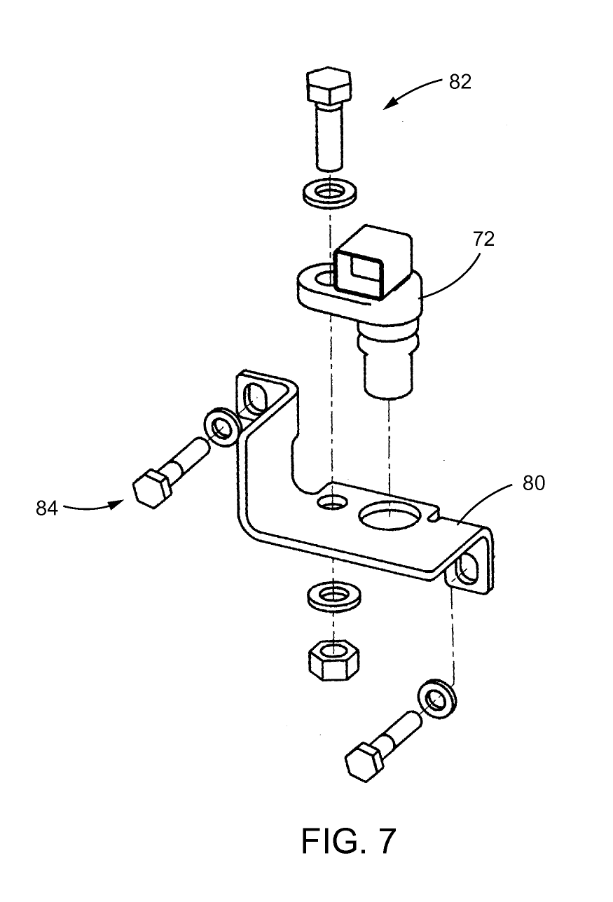

The sensor 72 may be of any appropriate type. For example, the sensor 72 may be a contacting sensor or a magnetic pickup sensor, particularly when utilized in conjunction with a steel annular toothed surface 70. The sensor 72 may be mounted to the machine frame 20 or a structure associated with the machine frame 20 by any appropriate mounting structure. As illustrated in FIG. 7, for example, the sensor 72 may be mounted by way of a mounting bracket 80 by one or more appropriate fasteners 82, and the mounting bracket 80 may be secured to the machine frame 20 by one or more appropriate fasteners 84. Thus, as with the annular toothed surface 70, the sensor 72 may be incorporated into existing machines as a part of a retrofit drive train protection system.

Returning to FIG. 2, the sensor 72 provides a signal 73 indicative of the speed of the input pulley 60 to the machine controller 74. The machine software may then monitor the speed of the input pulley 60, the speed of the engine 34 by way of electrical connection 86, and the position of the clutch valve 44 by way of electrical connection 88, and as will be explained in greater detail below. In the event of an obstacle strike, for example, the implement 12 will rapidly decelerate, which deceleration is transmitted through the implement drive gearbox 64 to the input pulley 60. Recognizing the deceleration in the input pulley 60 through the annular toothed ring 70 in conjunction with the sensor 72, the machine controller 74 provides a signal to the clutch valve 44 to disengage the clutch 48. In this way, the peak torque spike to the drive train 14 is significantly reduced.

The machine controller 74 of this disclosure may be of any conventional design having hardware and software configured to perform the calculations and send and receive appropriate signals to perform the disclosed logic. The machine controller 74 may include one or more controller units, and may be configured solely to perform the disclosed strategy, or to perform the disclosed strategy and other processes of the machine 10. The machine controller 74 may be of any suitable construction, and may include a processor (not shown) and a memory component (not shown). The processor may be microprocessors or other processors as known in the art. In some embodiments the processor may be made up of multiple processors. In one example, the machine controller 74 comprises a digital processor system including a microprocessor circuit having data inputs and control outputs, operating in accordance with computer-readable instructions stored on a computer-readable medium. Typically, the processor will have associated therewith long-term (non-volatile) memory for storing the program instructions, as well as short-term (volatile) memory for storing operands and results during (or resulting from) processing.

The machine controller 74 may be programmable. The processor may execute computer-executable instructions for controlling the clutch valve 44, such as the methods described herein. Such instructions may be read into or incorporated into a computer-readable medium, such as the memory component or provided external to processor. In alternative embodiments, hard-wired circuitry may be used in place of or in combination with software instructions to implement methods for control of the clutch valve 44. Thus, embodiments are not limited to any specific combination of hardware circuitry and software.

The term “non-transitory computer-readable medium” as used herein refers to any medium or combination of media that participates in providing instructions to processor for execution. Such a medium may take many forms, including but not limited to, non-volatile media, volatile media, and transmission media. Non-volatile media includes, for example, optical or magnetic disks. Volatile media includes dynamic memory. Transmission media includes coaxial cables, copper wire and fiber optics.

Common forms of non-transitory computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, or any other medium from which a computer or processor can read.

The memory component may include any form of computer-readable media as described above. The memory component may include multiple memory components.

The machine controller 74 may be enclosed in a single housing. In alternative embodiments, the machine controller 74 may include a plurality of components operably connected and enclosed in a plurality of housings. The machine controller 74 may be an integral part of a control panel (not shown). In another embodiment, the machine controller 74 may be fixedly attached to the driver 32, and/or the frame 20 in another location. In still other embodiments the machine controller 74 may be located in a plurality of operably connected locations including being fixedly attached to the frame 20, the driver 32, and/or remotely.

The machine controller 74 may be communicatively coupled to the clutch valve 44 through the at least one signal output port. The machine controller 74 may be communicatively coupled to the sensor 72 to receive the signal 73 indicative of the speed of the input pulley 60.

### INDUSTRIAL APPLICABILITY

The present disclosure is applicable to machines 10 including an implement 12 operated by a drive train 14 wherein the implement 12 may encounter obstacles that may provide sudden shocks that may otherwise damage the drive train 14. In a particular application, the disclosure relates to a cold planer 16 having a milling head or rotor 18,

The disclosure may provide a system and method that may provide rapid deceleration to the implement to minimize or eliminate damage resulting to such shocks. The system and method may provide enhanced control by monitoring speeds at a relatively high resolution.

Inasmuch as the drive train protection system 69 monitors the speed of the input pulley 60, that is, the speed input into the implement drive gearbox 64, the system 69 is able to monitor with a relatively high resolution inasmuch as the input speed magnitudes higher than the output speed of the implement drive gearbox 64 at the implement 12.

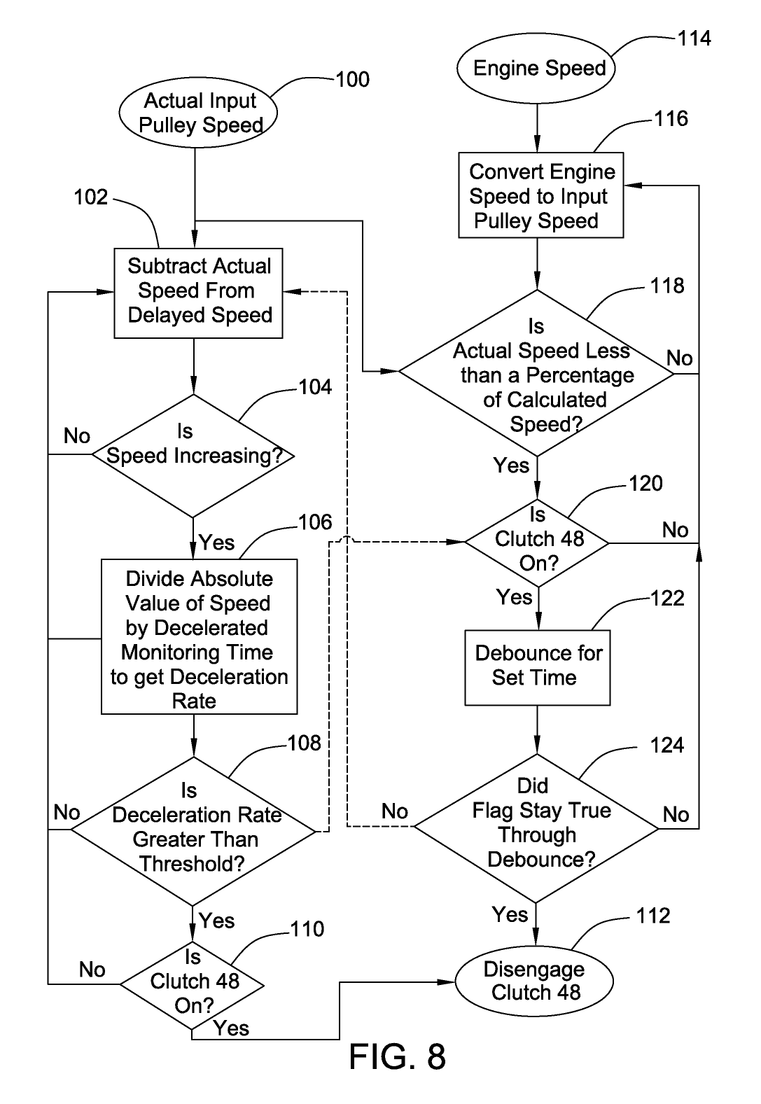

Turning now to FIG. 8, there is illustrated an exemplary method according to teachings of this disclosure. The illustrated logic embodiment includes substantially parallel evaluations based upon time and comparisons of actual and calculated speeds of the input pulley 60.

Looking to the left side of the logic diagram of FIG. 8, the actual speed of the input pulley 60 (box 100) is determined based upon the signal 73 from the sensor 72 to the machine controller 74 indicative of the speed of the input pulley 60. As explained in greater detail above, the speed of the input pulley 60 is indicative of the speed of the implement 12, here, rotor 18. Referring to box 102, a change in the speed of the input pulley 60 is determined by subtracting the actual speed of the input pulley 60 from a delayed speed of the input pulley 60. The delayed speed is a previously measured speed of the input pulley 60 at a set time interval. From this calculation, the method determines whether the speed of the input pulley 60 is decreasing (box 104). If the speed is not decreasing, the method continues calculating the difference between the actual speed and the delayed speed over the set time difference (box 102). Conversely, if the speed is decreasing, the deceleration rate is determined by dividing the absolute value of the difference by the time interval (box 106).

The deceleration rate calculated at box 106 is then compared with a preset deceleration threshold. In at least one embodiment, for example, the deceleration threshold may be on the order of 500 rpm/sec maintained over a minimum time period, such as, for example, 40 ms or the like. The deceleration threshold and the time period, however, may be greater or lesser as appropriate. In this way, the deceleration threshold may be tuned based upon the particular machine configuration and characteristics.

If the deceleration rate is not greater than the deceleration threshold, the calculations and determinations of boxes 102, 104, 106, and 108 continue based upon the continual input of the sensor 72 to the machine controller 74, providing a signal 73 that is indicative of the speed of the input pulley 60. If the deceleration rate is greater than the deceleration threshold, however, if the clutch 48 is on, that is, engaged (box 110), the machine controller 74 provides a signal, which results in the disengagement of the clutch valve 44, therefore disengaging the rotor from the driver 32, or engine 34 (box 112).

Turning now to the right side of the logic diagram of FIG. 8, utilizing the driver 32 or engine 34 speed (box 114), the machine controller 74 converts the engine speed to an input speed provided to the input pulley 60 (box 116). In the illustrated embodiment of FIGS. 2-3, the input speed from the engine is based upon the speed provided to the input belt 56 by way of the power drive arrangement 36, the clutch 48, and the pulley 58. Referring to box 118, the actual sensed input pulley 60 speed based upon the signal 73 from sensor 72 is compared with the calculated input speed provided to the input pulley 60 by way of the driver 32 or engine 34 and input belt 56. The comparison of the sensed input pulley 60 speed and the calculated speed is compared with discrepancy threshold value. It is understood that there may be some slip in the drive train 14 based upon tolerances, friction, and losses in transmission by the input belt 56. Accordingly, it is understood that there will be some losses within the system. As a result, this low discrepancy threshold may be tuned based upon the particular equipment utilized, and other features of the drive train 14.

In the illustrated embodiment, the actual sensed input pulley 60 speed is taken as a percentage of the calculated input speed based upon the driver 32 or engine 34, although alternate appropriate comparisons may be utilized. In developing a discrepancy threshold, the percentage of the calculated input speed may be determined that is permissible, and is not indicative of losses due to the implement 12, or rotor 18, encountering an obstacle. In at least one embodiment, for example, the discrepancy threshold may be on the order of 10% maintained for a period of time, such as, for example, more than ⅕ seconds.

If the calculated percentage is not less than the discrepancy threshold, the method continues with the conversion of the driver 32 or engine 34 speed into a calculated input speed (box 116), with a continued comparison (box 118) to the actual speed of the input pulley (box 100). Conversely, if the actual speed is less than the discrepancy threshold, that is, if the actual speed of the input pulley 60 is impermissibly low compared to the calculated speed, the implement 12, here, rotor 18, may have encountered an obstacle.

At box 120, it is determined whether the clutch 48 is engaged. If the clutch 48 is not engaged, then the difference in speed is not the result of encountering an obstacle, and the conversion at box 116 continues, along with the comparison to the actual speed at box 118. If the clutch 48 is engaged, however, it may be the result of the implement 12, here, rotor 18, encountering an obstacle.

It is noted, however, that some decelerations as well as differences between the calculated input speed and actual input speed may be the result of transitory events. For example, when the clutch 48 is initially engaged to cause rotation of the implement 12, here, rotor 18, the implement 12 does not instantly rotate. That is, debounce may occur over a relatively short period. It will be appreciated that when the clutch 48 is initially engaged the speed at that input pulley 60 will not be as calculated. Accordingly, provisions may be made for such debounce in the some embodiments of the method. As illustrated in FIG. 8, such provisions may be made both with the portion of the method related to an actual to calculated speed comparison, and with the portion of the method based upon a calculation of deceleration based upon actual speeds over time.

In the illustrated embodiment, for example, it may be determined if the machine 10 has already “debounced” for a debounce time after such an event; that is, if the implement 12 has been recently engaged, the method calculation is occurring at other than a debounce time following the engagement. Alternately, it may be determined if the event is maintained for a set debounce time period (box 122), the set debounce time period being sufficient to allow debounce to occur. If the event does not remain true following this debounce check (box 124), the method based upon a comparison of actual to calculated speed is repeated (boxes 114, 116, 118, 120), and/or the method based upon a calculation of deceleration based upon actual input pulley 60 speed (boxes 102, 104, 108, 120) is repeated. Conversely, if the event does remain true following the debounce check (box 124), then the machine controller 74 provides a signal resulting in the disengagement of the clutch 48 (box 112). Alternately, for example, a set debounce time period may be initiated at the beginning of the method, delaying the comparisons until such time as the set debounce time period has passed.

Within the context of the illustrated embodiment, either with the method based upon a comparison of actual to calculated speed, or the method based upon a calculation of deceleration based upon actual input pulley 60 speed, in indicating that the machine controller 74 provides a signal, which results in movement of the clutch valve 44 or disengagement of the clutch 48, it is understood that the implement drive status will change to disengaging, and follow a normal disengagement sequence, and a system propelling the machine 10 will be forced to the neutral state. Moreover, while the determination of whether the clutch 48 is engaged (boxes 110, 120) is illustrated in one or more specific locations in the logic diagram of FIG. 8, it will be appreciated that the machine controller 74 may be continually receiving a signal as to whether the clutch 48 is engaged. For example, the machine controller 74 monitors whether the clutch valve 44 is in an open or closed position, indicating whether the clutch 48 is engaged or disengaged.

It is further noted that the method may include specific provisions for faults in the monitoring system. For example, if the measured speed of the input pulley 60 is exactly 0 rpm for a given period of time (for example, 5 seconds), after the clutch valve 44 moves to a position for actuation of the clutch 48, the machine controller 74 can assume that the sensor 72 is faulted. As a result, the machine controller 74 may ignore the sensed speed of the input pulley 60 until the next engagement of the driver 32, here, engine 34, with input pulley 60 by way of the clutch 48.

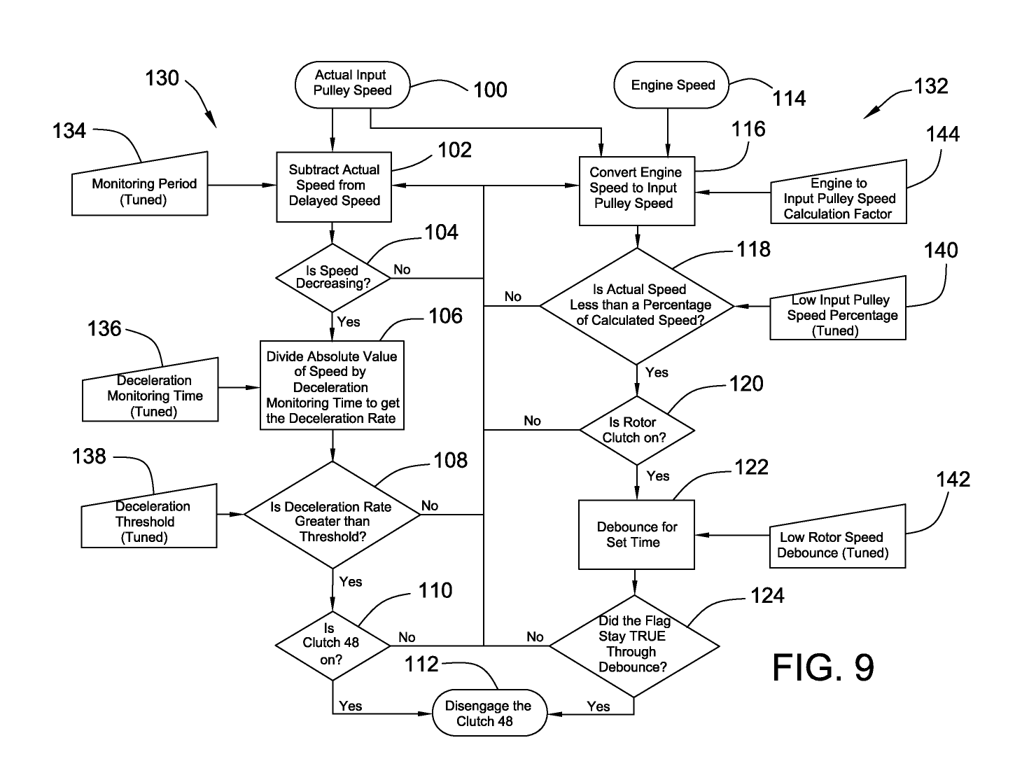

Turning now to the embodiment illustrated in FIG. 9, as with the embodiment of FIG. 8, the method includes evaluations based upon deceleration in the sensed actual speed of the input pulley 60 (see box 130), and based upon a comparison of the calculated speed of the input pulley 60 as compared to the sensed actual speed of the input pulley 60 (see box 130). For the sake of clarity, steps that are as set forth with regard to the method illustrated in FIG. 8 are designated with like reference numbers, and the explanations regarding the method of FIG. 8 are likewise applicable with regard to FIG. 9.

As set forth in FIG. 9, however, it is explicitly noted that a number of the considerations within the method may be specifically tuned. For the purposes of this application, the term “tuned” is intended to mean the development of a specific level based upon factors such as the configuration and structure of the machine 10, as well as the history of the operation of the machine 10. For example, with regard to the portion of the method based upon deceleration observed in the sensed actual speed of the input pulley 60, the monitoring period (box 134) between which the sensed actual speeds of the input pulley 60 are compared (box 102) may be tuned, as well as the deceleration monitoring time (box 136) utilized to determine the deceleration rate (box 106). Similarly, threshold levels may be tuned, such as the deceleration threshold (box 138) utilized in the evaluation of the deceleration rate (box 108), and the discrepancy threshold (box 140) regarding the comparison of the sensed actual speed of the input pulley 60 and the input pulley 60 speed calculated based upon the speed of the driver 32, here, engine 34 (box 118) may be tuned. Likewise, the time period of debounce (box 142) may be tuned. It will further be appreciated that the calculated speed of the input pulley (box 116) may be determined based upon a number of factors (box 144) including, for example, the output speed of the driver 32, here, engine 34, the design and particular engagement of the components within the power drive arrangement 36, as well as the tolerances of such components.

While the foregoing description provides examples of the disclosed system and technique, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

We claim:

1. A drive train protection system for a machine having a rotatably-mounted implement and a drive train coupled to a driver and the implement, the drive train including an implement drive gearbox coupled to the implement to provide rotary movement, the driver being selectively couplable to provide rotary movement to the implement drive gearbox by at least one input belt, the drive train protection system comprising:
an input pulley coupled to the implement drive gearbox, the input belt being disposed to provide rotary movement to the input pulley, the input pulley including an annular toothed surface,
at least one sensor disposed to sense the rotation of the annular toothed surface to monitor a speed of the input pulley and a provide a signal indicative of a speed of the input pulley, and
at least one clutch selectively engagable to provide rotary movement to the input pulley from the driver, and disengagable to disengage the input pulley from the driver in response to the signal indicative of the speed of the input pulley.

2. The drive train protection system of claim 1 wherein the input pulley includes a wheel and a ring, and the ring includes the annular toothed surface, the ring being secured to the wheel.

3. The drive train protection system of claim 1 wherein the annular toothed surface includes a plurality of teeth and valleys substantially uniformly spaced about the annular toothed surface, the sensor being disposed to monitor the movement of the teeth past the sensor.

4. The drive train protection system of claim 1 wherein the sensor is a magnetic pickup sensor.

5. The drive train protection system of claim 1 further including a programmable controller, the sensor being adapted to provide a signal indicative of the speed of the input pulley to the programmable controller, the programmable controller being configured by computer-executable instructions to monitor the speed.

6. The drive train protection system of claim 5 wherein the programmable controller is further configured by computer-executable instructions to identify at least one of a rapid deceleration of the speed of the input pulley and a discrepancy threshold difference between a sensed speed of the input pulley and a calculated speed provided to the input pulley from the driver, and to provide a signal to disengage the selectively engagable clutch associated with rotary movement of the implement.

7. The drive train protection system of claim 6 wherein the annular toothed surface includes a plurality of teeth and valleys substantially uniformly spaced about the annular toothed surface, the sensor being disposed to monitor the movement of the teeth past the sensor, and the sensor is a magnetic pickup sensor.

8. A cold planer comprising:
a plurality of ground engaging devices;
a frame supported on the plurality of ground engaging devices;
a driver supported on the frame;
a rotor;
a drive train coupled to the driver and the rotor, the drive train including
an implement drive gearbox coupled to the rotor to provide rotary movement,
an input pulley, the input pulley including an annular toothed surface, the input pulley being coupled to the implement drive gearbox,
at least one input belt disposed to provide rotary movement to the input pulley,
a power drive coupled to the driver, and selectively couplable to provide rotary movement to the input belt, and
at least one sensor disposed to sense the rotation of the annular toothed surface to monitor a speed of the input pulley.

9. The cold planer of claim 8 wherein the power drive is selectively couplable to provide rotary movement to the input belt by at least one clutch.

10. The cold planer of claim 8 wherein the input pulley includes a first and second sides bridged by an outer annular surface, the annular toothed surface being disposed substantially adjacent at least one of the first and second sides.

11. The cold planer of claim 10 wherein the input pulley includes a wheel and a ring, and the ring includes the annular toothed surface.

12. The cold planer of claim 11 wherein the wheel and the ring are integrally formed.

13. The cold planer of claim 11 wherein the ring is secured to the wheel.

14. The cold planer of claim 11 wherein the ring is formed of steel.

15. The cold planer of claim 8 wherein the annular toothed surface includes a plurality of teeth and valleys of substantially equal length.

16. The cold planer of claim 8 wherein the sensor is a magnetic pickup sensor.

17. The cold planer of claim 8 further including a programmable controller, the sensor being adapted to provide a signal indicative of the speed of the input pulley to the programmable controller, the programmable controller being configured by computer-executable instructions to monitor the speed of the input pulley.

18. The cold planer of claim 17 wherein the programmable controller is further configured by computer-executable instructions to identify at least one of a rapid deceleration of the speed of the input pulley and a discrepancy threshold difference between a sensed speed of the input pulley and a calculated speed provided to the input pulley from the driver, and to provide a signal to disengage a clutch associated with rotary movement of the rotor.

19. A drive train for operation with an engine, the drive train comprising:
a power drive coupled for selective operation with the engine,
an implement drive gearbox,
a rotatably-mounted implement disposed for operation with the implement drive gearbox,
an input pulley disposed to transmit rotary movement to the implement drive gearbox, the input pulley including an annular toothed surface,
an input belt disposed about the input pulley,
a selectively engagable clutch disposed to selectively engage the power drive with the input belt,
at least one sensor disposed to sense rotation of the annular toothed surface to monitor a speed of the input pulley and a provide a signal indicative of the speed of the input pulley, and
a machine controller adapted to receive the signal and to provide a signal to disengage the clutch to disengage the power drive from the input belt when the implement encounters an obstacle.

20. The drive train of claim 19 wherein the power drive includes a planetary gearing arrangement, and the implement drive gearbox includes a planetary gearing arrangement.
